(19) United States
(12) Patent Application Publication
(10) Pub. No.: US 2010/0290763 A1
(43) Pub. Date: Nov. 18, 2010

(54) MULTI-CHAMBER WATER HEATER

(76) Inventors: Andre Boulay, L'ile-Bizard (CA); Jason M. Gallovich, Valleyfield (CA); Yvon White, Pierrefonds (CA)

Correspondence Address: Pearl Cohen Zedek Latzer, LLP, 1500 Broadway, 12th Floor, New York, NY, 10036, US

(21) Appl. No.: 12/809,531

(22) PCT Filed: Dec. 22, 2008
(86) PCT No.: PCT/CA2008/002270

§ 371 Date: Jun. 18, 2010

Related U.S. Application Data
(60) Provisional application No. 61/015,457, filed on Dec. 20, 2007.

(51) Int. Cl. F24H 1/20; H05B 1/02

(52) U.S. Cl. 392/451; 219/494

(57) ABSTRACT

A water heater which includes a tank (60) with a water inlet (64) and outlet (26). At least one divider (18) for dividing the tank into a plurality of chambers (12), (14) with adjacent chambers being arterial (28). A first chamber (14) is connected to the outlet and another one of the chambers (12) is connected to the inlet. Heating means (20) may be located in some or all of the chambers. The dividers may be oriented vertically or horizontally (18). They may be movable and of specific construction including apertures (28) therein for arterial connection to adjacent chambers which apertures may contain flow control thermostats. They may be insulated to reduce heat transfer between compartments. Where displacement is via density/temperature changes in a compartment, stops may be provided to limit the travel of the dividers/partitions. Sacrificial protection (74) may be provided for the tank.

### CROSS-REFERENCE TO RELATED APPLICATIONS

The present application claims priority under 35 USC §119(e) of Provisional Patent Application bearing Ser. No. 61/015,457, filed on Dec. 20, 2007, the contents of which are hereby incorporated by reference.

### TECHNICAL FIELD

The present invention relates to the field of hot water tanks.

### BACKGROUND

In conventionally constructed hot water heaters there is provided an insulated cylindrical metal tank, in which water to be heated is stored. All of the stored water is heated to the desired temperature. The temperature is then maintained at the desired level throughout the entire tank. The heating cycles are controlled via a mechanical thermostat with little or no duty cycle control capabilities. Once the water temperature within the tank reaches a level that is below the desired temperature, the thermostat is turned on and the heating cycle begins and is ended when the set temperature is attained.

Also, conventional tanks generally provide an inlet and an outlet for incoming cold water and outgoing hot water flow. When a hot water tap is opened, hot water flows out of the tank to the tap or appliance being used and cold water then is allowed to flow into the tank and is mixed in with the hot water. The entering of cold water in the water heater results in a cooling effect on the remaining hot water and subsequently reduces the usable hot water capacity of the tank.

Therefore, there is a need for maintaining the usable hot water capacity of a water heater.

### SUMMARY

According to a broad aspect, there is provided a water heater comprising: a tank having an inlet for entering cold water and an outlet for exiting hot water; at least one divider located inside the tank, the at least one divider dividing the tank into a plurality of chambers, two adjacent ones of the plurality of chambers being fluidly connected, a first one of the plurality of chambers being connected to the outlet and containing the hot water, and a last one of the plurality of chambers being connected to the inlet; at least one heating element located in the first one of the plurality of chambers; and a control unit for adjusting a temperature of the at least one heating element.

The divider may be movable within the tank in order to adjust the volume of hot water contained in the tank. Alternatively, the divider may have a fixed position within the tank and a cold water chamber is provided with a heating element in communication with the control unit. By turning on the heating element of the cold water chamber, the volume of available hot water is increased. The divider may be insulated to provide better heat separation.

### BRIEF DESCRIPTION OF THE DRAWINGS

Further features and advantages of the present invention will become apparent from the following detailed description, taken in combination with the appended drawings, in which:

FIG. 1 illustrates a multi-chamber water heater comprising a single moveable divider defining two chambers, in accordance with an embodiment;

FIG. 2 illustrates a multi-chamber water heater comprising three fixed dividers and four heating devices, in accordance with an embodiment; and

FIG. 3 illustrates a multi-chamber water heater comprising one moveable divider, two fixed dividers, and three heating elements, in accordance with an embodiment.

It will be noted that throughout the appended drawings, like features are identified by like reference numerals.

### DETAILED DESCRIPTION

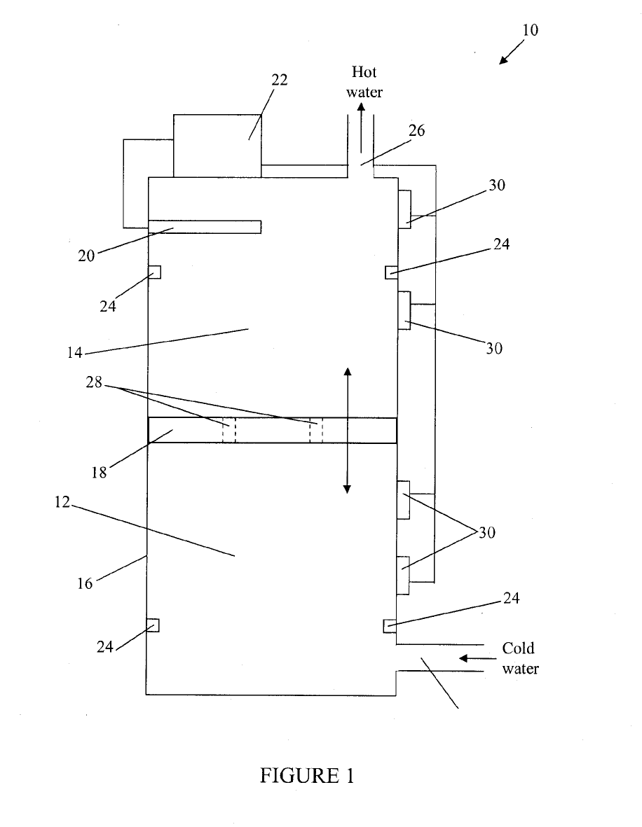

FIG. 1 illustrates one embodiment of a multi-chamber water heater 10 comprising two chambers 12 and 14.

The multi-chamber water heater 10 includes a tank 16, a moveable divider 18, a heating element 20 and a control unit 22. The moveable divider 18 divides the tank 16 into the two chambers 12 and 14: the first chamber 12 for cold water entering by a cold water inlet 24 and a second chamber 14 for hot water exiting the tank 16 by a hot water outlet 26. The hot water chamber 14 includes a heating element 20 for heating the water. The moveable divider 18 moves vertically inside the tank to adjust the volume of the hot water chamber 14. Displacement means are provided to allow for the displacement of the moveable divider 18. The volume of the hot water chamber 14 is controlled by the position of the moveable divider 18 inside the tank 16. The control unit 22 controls the heating element 20 present in the hot water chamber 14 to adjust the temperature of the hot water and may be used to displace the moveable divider 18 along the tank.

The moveable divider 18 is used to eliminate or reduce the undesired mixing of incoming cold water with the hot water stored within the tank 16 in order to maximize user comfort and energy efficiency, and reduce energy costs. This moveable divider 18 is insulated in order to prevent the mixing of heated and cold liquid stored within the tank 16. Preventing the mixing of hot and cold liquid within the tank 16 serves to eliminate the cooling of the hot liquid when the cold water flows into the tank 16 during use. Eliminating this cooling effect increases the overall capacity of usable hot liquid stored within the tank 16. This also increases the overall efficiency of the system and therefore helps to reduce energy costs. The use of the moveable divider 18 reduces the unneeded amount of water being heated and maintained at set temperatures, therefore reducing energy use and costs.

In one embodiment, the moveable divider's 18 movement within the tank 16 dynamically controls the hot and cold water proportions stored within the tank 16. The dynamic movement of the moveable divider 18 is caused by variations in density of hot water which is in turn controlled by the heating and cooling cycles within the tank 16. Any material or combination of material which renders the moveable divider 18 neutrally buoyant such that its movement is only caused by the changes in water density can be used. Water bleeder holes cross the moveable divider 18. When the volume of hot water has to be increased, the temperature of the hot water is increased via the heating element 20. The volume of the hot water contained in the hot water chamber 14 increases as a result of the increased temperature. As the water is heated, there is a change in density, which causes the divider 18 to move downwards. The volume of cold water passing from the cold water chamber 12 to the hot water chamber 14 corresponds to the further needed hot water volume. The increase of the hot water chamber volume is equal to the surface area of the moveable divider 18 multiplied by the distance traveled by the moveable divider 18. The temperature of the hot water is maintained at an appropriate level to have the desired volume of hot water.

In another embodiment, the dynamic movement of the moveable divider 18 is performed mechanically by using a motor driven track system controlled by the control unit 22, which allows the moveable divider 18 to travel up and down inside the tank 16. It should be understood that any mechanical means allowing the displacement of the divider 18 within the tank 16 can be used.

A further embodiment includes the use of a thermostatic mixing valve such as the type found in a vehicle cooling system, mounted onto the moveable divider in such a way as to allow water flow from one chamber to the other once a particular temperature is reached.

In one embodiment, the moveable divider 18 has substantially the same cross-sectional shape as that of the internal part of the tank, and the surface area of the cross section of the moveable divider 18 is slightly inferior to that of the cross section of the internal part of the tank. Alternative cross-sections and shapes are possible for the moveable divider 18, as long as a separation is provided between the hot water and the cold water.

In one embodiment, the moveable divider 18 is made of a material that is not affected by temperature fluctuations and the moveable divider 18 can be maintained stable within the tank 16. Alternatively, the moveable divider 18 can be balanced by adding weights.

In one embodiment, stoppers 24 are placed along the moveable divider's 18 path inside the tank 16 to ensure a minimum hot water chamber 14 volume and a minimum cold water chamber 12 volume.

In one embodiment, the control unit 22 comprises an on/off button to control the heating element 20 which can only be in two states, namely a non-heating state and a heating state in which it heats water at a non-varying predefined temperature. Alternatively, the temperature of the heating element 20 can take any value between zero and a maximum temperature. Any control unit or module for controlling the temperature of any heating element or device can be used.

In one embodiment, the control unit 22 includes a CPU controller for controlling heating and cooling cycles. At least one temperature sensor 30 is placed inside the tank 16 to inform the CPU controller about the water temperature. Furthermore, this control unit 22 comprises a memory for storing heating period information which include heating period preferences and/or historical usage patterns, for example, in order to more precisely and more efficiently control heating and cooling cycles. The control unit 22 controls the available volume of hot water, as well as its temperature. The control unit's 22 memory may also include data such as calendar events, holidays, homecomings, seasonal changes, etc.

In one embodiment, the multi-chamber water heater 10 is provided with a means for remotely controlling the CPU of the control unit 22 and/or updating the memory of the control unit 22. This is achieved via wired and/or wireless means of communication and/or data transfer. The updating and/or control may be completed by a third party such as an energy service provider. The service provider has the capability of updating the controller unit's 22 memory with new heating period preferences, further increasing the level of energy efficiency and cost savings. The new heating period preferences can be determined according to peak energy demand period information, for example. The new peak energy demand period information relates to the time periods during which the electricity or other energy sources are the most consumed. The cost of the energy source may be dependant on the global consumption. For example, the cost can be higher in the morning than at night. In this case, the control unit chooses the time periods during which the water is heated on the basis of the peak energy demand period information and of historical usage patterns. Doing so, the control unit avoids peak energy demand periods which results in cost savings. Alternatively, the updating of the control unit 22 can be done manually. For example, a computer can be connected to the control unit and data can be transferred from the computer, or a user can input data directly into the control unit 22 via an interface.

In one embodiment, the CPU controller is programmed to eliminate the possibility of causing new peak energy demand periods, in the case of mass adoption of the present multi-chamber water heater. A first method for avoiding new peak energy demand periods is to make the heating cycles last over a longer period of time for a one week period every month, for example, thus making energy consumption more linear. A second method consists in introducing fixed and/or variable time slots at which the multi-chamber water heater 10 initiates and completes the heating cycles. A third method consists in monitoring the unit's supply voltage and/or current in order to detect lower levels willingly or unwillingly caused by the energy service provider during extreme weather conditions, thus equating this phenomenon to a peak period.

In one embodiment, the multi-chamber water heater 10 has the ability to modify its behaviour upon resumption of electrical service following a power outage. This capability serves to eliminate harmful phenomena such as power surges that often occur when electrical demand is too high upon resumption of electrical service.

In one embodiment, the multi-chamber water heater 10 provides substantial water savings by virtue of the fact that the set temperature is at a lower value than conventional set temperatures, for example 132° F. rather than 145° F. The multi-chamber water heater 10 causes less cold/hot water mixing in order to provide for example, a comfortable shower temperature of 104° F. The set temperature of 132° F. is made possible by the use of the moveable divider 18 which prevents cold and hot water mixing during regular water consumption.

A further added benefit is an increased level of security by reducing the risk of burns related to high temperature settings on conventional hot water heaters. For example the burn time, defined as the maximum duration until injury, at a set temperature of 145° F. is 3 seconds for an adult and 1.5 seconds for a child under the age of 5 whereas the burn time at a set temperature of 132° F. is 30 seconds for an adult and 10 seconds for a child. Statistically, the risk of burns associated to the present multi-chamber water heater 10 can be reduced by a factor of 10.

In another embodiment, the multi-chamber water heater 10 comprises an additional heating element located in the cold water chamber 12. The additional heating element is controlled by the control unit 22. The role of this second heating element is to kill bacteria and limit its reproduction in the cold water chamber. Periodically, the outlet of the multi-chamber is closed and the second heating element is heated at a temperature suitable for killing the bacteria contained in the cold water chamber.

In one embodiment, the position of the moveable divider is controlled by adjusting the density of both the hot and cold water. This is done by adjusting the relative temperatures of the cold and hot water via the heating elements present in the cold water chamber 12 and the hot water chamber 14, respectively.

In one embodiment, when the multi-chamber water heater 10 comprises a heating element in the cold water chamber 12, the divider 18 can have a fixed position in the tank 16. In this case, the cold water chamber 12 and the hot water chamber 14 each have a fixed volume. By heating the water contained in the cold water chamber 12, the total volume of hot water available to the user is increased.

In one embodiment, the hot water chamber 14 is provided with blending means for blending the hot water. When entering the hot water chamber 14, cold water is blended with the hot water. Thus, the temperature of the water contained in the hot water chamber 14 is uniform. In addition to increasing the effectiveness of the heating cycle, the level of comfort is increased since the hot water available for the user is set at a uniform temperature. If the multi-chamber water heater 10 is provided with an additional heating element in the cold water chamber 12, blending means can also be provided in the cold water chamber 12.

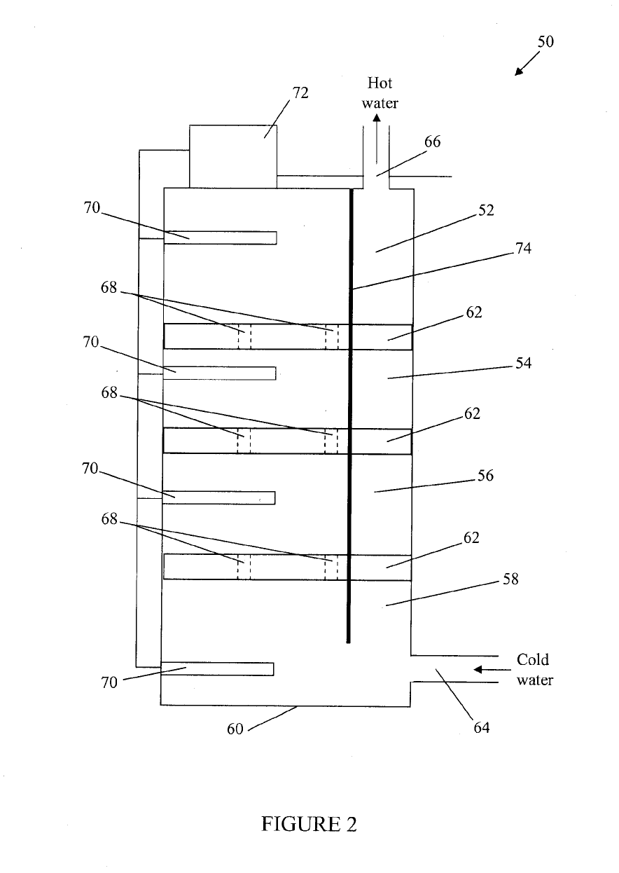

FIG. 2 illustrates one embodiment of a multi-chamber water heater 50 having four fixed volume chambers 52, 54, 56, and 58. The multi-chamber water heater 50 comprises a tank 60 and three fixed dividers 62. The tank 60 is provided with an inlet 64 for entering cold water and an outlet 66 for exiting hot water. The three fixed dividers 62 have a fixed position within the tank 60 and divide the tank 60 into four chambers 52, 54, 56, and 58 having a fixed volume. At least one water bleeder hole crosses 68 each fixed divider. Water can pass from one chamber to an adjacent chamber through the water bleeder hole 68. Each chamber 52, 54, 56, 58 is provided with a heating element 70, each being controlled by a control unit 72.

The control unit 72 controls the volume and the temperature of the hot water by controlling the heating elements 70. If a small volume of hot water is required, only the heating element 70 of the top chamber 52 is heated to a desired temperature. If more hot water is required, the control unit 72 increases the temperature of the heating element of the adjacent chamber 54 to the desired temperature. If a maximum volume of hot water is required, the heating elements 70 of all of the chambers 52, 54, 56, and 58 are heated at a desired temperature and each chamber 52, 54, 56, 58 contains hot water.

When hot water exits the multi-chamber water heater 50, cold water enters the chamber 58 located at the bottom of the tank 60. A volume equivalent to the volume of the entering cold water passes from one chamber 54, 56, 58 to an above chamber 52, 54, 56 using the water bleeder holes 68 of the fixed dividers 62. Water entering a chamber mixes with the remaining water present in the chamber. In the case of cold water entering a hot water chamber, cold and hot water may be mixed and the temperature of the mixed water is then brought to a desired temperature by the heating element 70.

In one embodiment, the control unit 72 comprises a thermostat which controls the temperature of the heating elements 70. By turning-off the heating element 70 of a chamber 52, 54, 56, 58, the corresponding chamber 52, 54, 56, 58 becomes a cold water chamber containing cold water. In one embodiment, the user directly sets the temperature of each heating element 70. In another embodiment, the user enters the volume of desired hot water into the control unit 72 via an interface. The control unit 72 is adapted to turn on the appropriate heating elements 70 in order to obtain the desired hot water volume.

In another embodiment, the control unit 72 is provided with a CPU and is adapted to perform some or all of the functions described above with respect to the control unit 22.

In one embodiment in which the tank 60 is made of metal, the multi-chamber water heater 50 is provided with an anode rod 74 in order to protect against corrosion of the tank 60. The anode rod 74 extends across the chambers 52, 54, 56, and 58 and can be made of aluminum or magnesium, for example. The anode rod 74 is also referred to as a sacrificial anode since it dissolves slowly and sacrifices itself to protect the metal tank 60.

While the present embodiment includes four chambers 52, 54, 56, and 58, it should be understood that the number and the volume of the chambers may vary. For example, the volume of the chamber 52 may be greater than that of the other chambers 54, 56, and 58. Alternatively, the dividers are positioned in the tank 60 such that the chambers 52, 54, 56, and 58 have a same volume. The multi-chamber water heater may comprise any number of chambers as long as it comprises at least two chambers separated by a divider.

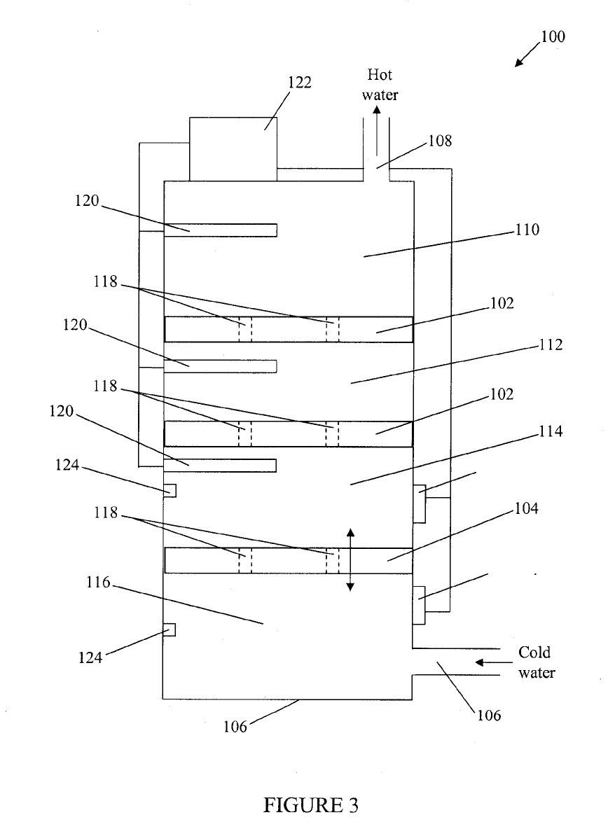

FIG. 3 illustrates one embodiment of a multi-chamber water heater 100 combining two fixed dividers 102 and 103 and one moveable divider 104. The multi-chamber water heater 100 comprises a tank 103, the two fixed dividers 102 and the moveable divider 104. The tank 60 is provided with an inlet 106 for entering cold water and an outlet 108 for exiting hot water. The two fixed dividers 102 have a fixed position within the tank 106 while the moveable divider 104 can move within the tank 106. The three dividers divide the tank 106 into four chambers 110, 112, 114, and 116 of which the two top chambers 110 and 112 have a fixed volume and the two bottom chambers 114 and 116 have a varying volume. At least one water bleeder hole 118 crosses each divider 102. Water can pass from one chamber 112, 114, 116 to an adjacent chamber 110, 112, 114 through the water bleeder holes 118.

In one embodiment, the three top chambers 110, 112, and 114 are provided with a heating element 120, each being controlled by a control unit 122. Alternatively, the bottom chamber 116 may also be provided with a heating element. By controlling the temperature of the heating elements 120 and the position of the moveable divider 104, the control unit 122 controls the temperature and the volume of the hot water contained in the tank 106. Stoppers 124 may be provided to define a minimum volume for the variable-sized chambers 114 and 116.

In one embodiment, the dynamic movement of the moveable divider 104 is caused by variations in water density which is in turn controlled by the heating and cooling cycles within the tank 106. In this case, a temperature sensor in communication with the control unit 122 can be used to obtain a better control of the temperature of water in the chamber 114, which in turn offers a better control on the volume of the chamber 114. In another embodiment, the dynamic movement of the moveable divider 104 is performed mechanically by using a motor driven track system which allows the moveable divider to travel up and down inside the tank.

In another embodiment, at least one thermostatic mixing valve, such as the type found in a vehicle cooling system, is mounted onto the divider 102, 104 in such a way as to allow water flow from one chamber 112, 114, 116 to the other chamber 110, 112, 114 once a particular temperature is reached.

While the multi-chamber water heater 100 includes four chambers 110, 112, 114, and 116, it should be understood that the number of fixed and moveable dividers, and the volume of the chambers, may vary.

In one embodiment, the multi-chamber water heater 100 is provided with at least one temperature sensor to monitor the temperature of water. For example, four temperature sensors in communication with the control unit 122 are used to determine the temperature of water in the four chambers 110, 112, 114, and 116.

While only FIG. 2 illustrates a multi-chamber water heater 50 comprising an anode rod 74, it should be understood that an anode rod can be provided within any multi-chamber water heater of which the tank is made of metal.

In one embodiment, the holes in the dividers necessary for the anode rod are substantially larger than the diameter of the anode rod. These holes allow water to cross the dividers and act as water bleeder holes. In another embodiment, the hole for the anode rod is substantially hermetically closed such that no water can pass through this hole. In a further embodiment, the anode rod acts as a guide for the moveable divider and prevents an unwanted rotation of the moveable divider during its displacement. Alternatively, each chamber can be provided with a corresponding anode rod. It should be understood that any corrosion protection means can be used.

In one embodiment, the fixed divider has substantially the same cross-sectional shape and surface area as those of the internal part of the tank. Alternative cross-sections and shapes are possible for the fixed divider, as long as a separation is provided between the hot water and the cold water.

While the figures illustrate the tank with the hot water provided in the upper chamber and the cold water provided in the lower chamber, the tank may be configured to have the two chambers side-by-side, or to have the cold water in the upper chamber and the hot water in the lower chamber.

In one embodiment, the moveable and/or fixed dividers are made of a waterproof material in order to prevent an undesired mixing of cold and hot water. For example, hydrophobic material can be used. In another embodiment, the moveable and/or fixed dividers are made of thermal insulating material to reduce the cooling of the hot water. For example, the dividers can be made of polystyrene or rubber.

It should be understood that any electrical and/or mechanical, and/or software means known by a person skilled in the art to displace a moveable divider within the tank can be used and falls within the scope of the invention. Any means for fluidly connecting two adjacent chambers can also be used. The connection can be made through the moveable or fixed divider. Alternatively, the connection can be made external to the fixed or moveable divider. For example, a hole can cross the moveable or fixed divider. A valve can be added to prevent a mixing of cold and hot water when not required.

It should be understood that any heating element adapted to heat water and any temperature sensor adapted to determine the temperature of water can be used.

While the present description refers to a single heating element/device per chamber, a person skilled in the art will understand that more than one heating element/device may be located in a chamber.

In one embodiment, the multi-chamber water heater is provided in similar outer dimensions and connections such as the ones found on conventional water heaters. In one embodiment, the multi-chamber water heater requires the same electrical and/or other energy sources as the ones found on conventional water heaters. For example, the heating element can be an electrical heating element, a gas burner, etc.

The embodiments of the invention described above are intended to be exemplary only. The scope of the invention is therefore intended to be limited solely by the scope of the appended claims.

1. A water heater comprising:
a tank having an inlet for entering cold water and an outlet for exiting hot water;
at least one divider located inside said tank, said at least one divider dividing said tank into a plurality of chambers, two adjacent ones of said plurality of chambers being fluidly connected, a first one of said plurality of chambers being connected to said outlet and containing said hot water, and at last one of said plurality of chambers being connected to said inlet;
at least one heating element located in said first one of said plurality of chambers; and
a control unit for adjusting a temperature of said at least one heating element.

2. The water heater as claimed in claim 1, wherein said at least one divider is displaceable inside said tank to a position corresponding to a desired volume of said hot water.

3. The water heater as claimed in claim 2, further comprising displacement means to move said at least one divider inside said tank.

4. The water heater as claimed in claim 3, wherein said displacement means are controlled by said control unit.

5. The water heater as claimed in claim 1, further comprising another beating element located in another one of said plurality of chambers and controlled by said control unit.

6. The water heater as claimed in claim 1, wherein said at least one divider is fixedly attached to said tank.

7. The water heater as claimed in claim 1, further comprising at least one temperature sensor positioned within said tank and in communication with said control unit to determine a temperature of water contained in at least one of said plurality of chambers.

8. The water heater as claimed in claim 1, further comprising at least one thermostatic valve mounted on said at least one divider to allow water to flow between said two adjacent ones of said plurality of chambers once a given temperature is reached.

9. The water heater as claimed in claim 1, further comprising a first stopper positioned within said tank to define a minimum volume for said first one of said plurality of chambers.

10. The water heater as claimed in claim 9, further comprising a second stopper positioned within said tank to define a minimum volume for said last one of said plurality of chambers.

11. The water heater as claimed in claim 1, wherein said control unit comprises a processing unit for controlling said at least one heating element and a memory for storing heating period information, said heating period information comprising at least one of heating period preferences and historical usage patterns.

12. The water heater as claimed in claim 11, wherein said control unit comprises communications means for one of remotely controlling said processing unit and updating said heating period information.

13. The water heater as claimed in claim 1, further comprising an anode rod attached within said tank and extending through said at least one divider.

14. The water heater as claimed in claim 1, wherein said at least one divider comprises at least one divider that is fixedly attached to said tank and at least one divider that is displaceable inside said tank.

15. The water heater as claimed in claim 1, wherein said at least one divider comprises a single divider dividing said tank into a hot water chamber connected to said outlet and a cold water chamber connected to said inlet.

16. The water heater as claimed in claim 1, wherein said at least one divider is horizontally positioned inside said tank and said plurality of chambers are stacked one on top of another.

17. The water heater as claimed in claim 1, wherein said at least one divider is positioned vertically inside said tank and said plurality of chambers are stacked in a side-by side configuration.

18. The water heater as claimed in claim 1, wherein said at least one heating element is an electrical heating element.
